(19) United States
(12) Patent Application Publication
(10) Pub. No.: US 2004/0240009 A1
(43) Pub. Date: Dec. 2, 2004

(54) Flat display comprising a frontal mask for the spatial, stereoscopic and/or holographic representation of information

(76) Inventor: Armin Schwerdtner, Dresden (DE)

Correspondence Address: GUDRUN E. HUCKETT DRAUDT, LONSSTR. 53, WUPPERTAL, 42289, DE

(21) Appl. No.: 10/491,364

(22) PCT Filed: Oct. 2, 2002
(86) PCT No.: PCT/DE02/03794

(30) Foreign Application Priority Data
Oct. 2, 2001 (DE) 10149723.7

(51) Int. Cl. G02B 5/32; G02B 1/10

(52) U.S. Cl. 359/15; 359/580

(57) ABSTRACT

An arrangement for spatial stereoscopic and/or holographic representation of information has a flat display having a rough surface and a frontal mask connected to the flat display. The rough surface has an immersing layer or a transparent layer or both provided thereon. As an alternative, between the rough surface of the flat display and the mask a space is provided and a closed body made of transparent material and containing immersing material is positioned in the space between the rough surface of the flat display and the mask.

### BACKGROUND OF THE INVENTION

The invention relates to flat displays with a frontal mask for spatial stereoscopic and/or holographic representation of information.

### SUMMARY OF THE INVENTION

It is an object of the invention to improve the quality of spatial stereoscopic or holographic representation on known flat displays that have a rough surface.

This object is solved in that a rough surface of the flat display is provided with an immersing layer and/or with a transparent layer or in that between the surface of the flat display and the mask is transparent and/or immersing material is located.

The embodiment, wherein the space between the surface of the flat display and the mask contains immersing material, results in a simple possibility for expanding on already present flat displays by means of the mask.

A sealed space between the surface of the flat display and the mask containing an immersing or transparent material results in a compact flat display for spatial stereoscopic and/or holographic representation.

With the embodiment, wherein the mask is arranged slidably relative to the flat display, the viewer of the stereoscopic or holographic representation is able to change his position without this decreasing the image quality for this viewer. Advantageously, the mask is being tracked in accordance with the new position of the viewer. This is realized by a position determination of the viewer wherein the mask is being tracked by means of a drive coupled thereto.

With at least one λ/2 layer, anti-reflective properties are advantageously provided to the flat display according to the invention.

### BRIEF DESCRIPTION OF THE DRAWINGS

Embodiments of the invention are illustrated in the drawings and will be described in the following in more detail.

It is shown in the following in a plan view, respectively, in:

FIG. 1 a basic illustration of a flat display illustrating the generation of scattered light due to the roughness of the surface of the flat display;

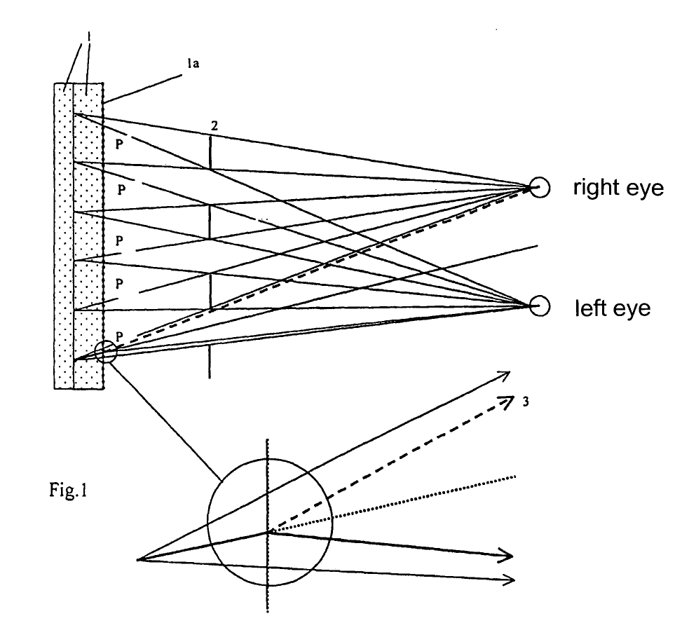

FIG. 2 a basic illustration of a flat display with a possibility of suppressing the scattered light by means of an immersing material;

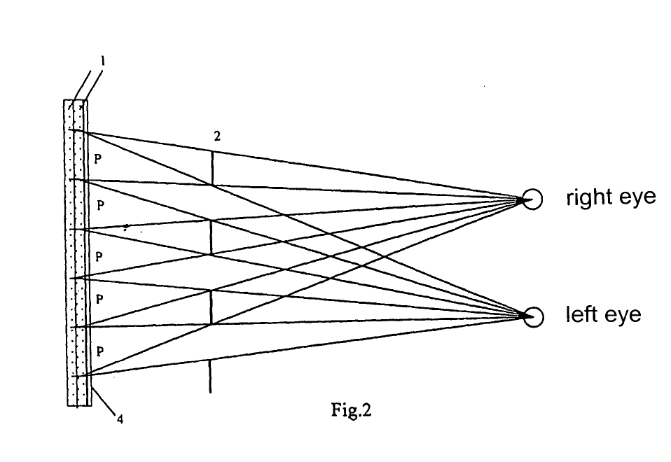

FIG. 3 a basic illustration of a flat display with an additional transparent layer;

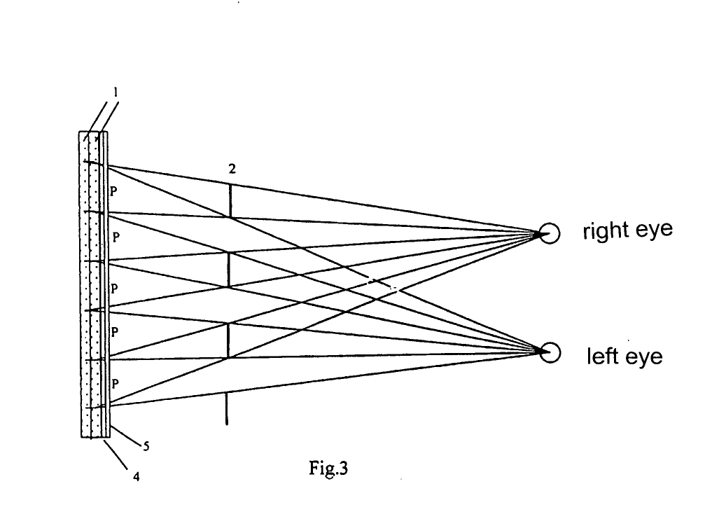

FIG. 4 a basic illustration of a flat display with additional anti-reflective properties provided by a λ/2 layer;

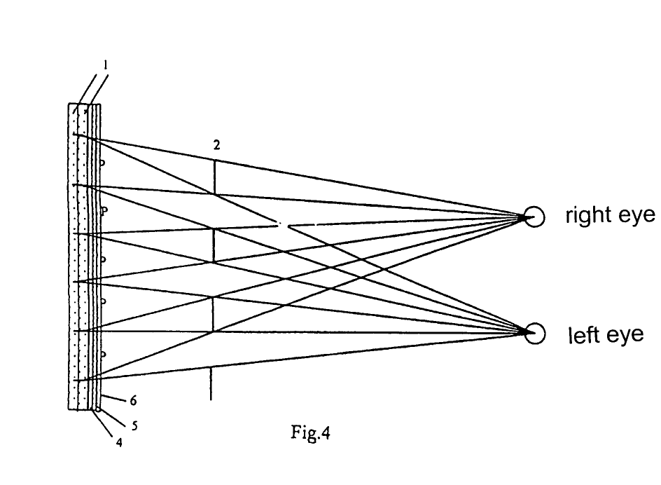

FIG. 5 a basic illustration of a flat display with a material for immersion positioned between the surface of the flat display and a mask for stereoscopic representation,

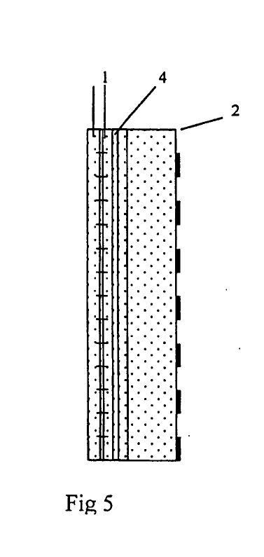

FIG. 6 immersing material contained in a closed space between the flat display and the mask 2,

FIG. 7 a mask slidably arranged by means of the immersing layer and a flexible seal, wherein the letter P indicates the pixel columns in the flat displays and wherein these pixel columns are either luminous or are provided with background lighting.

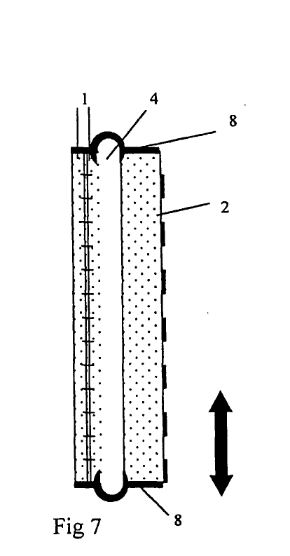

### DESCRIPTION OF PREFERRED EMBODIMENTS

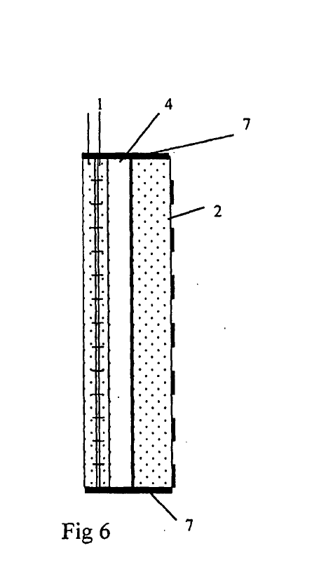

In one variant of the second embodiment (FIG. 6), an immersing material can be contained in a closed space similar to a layer 4 between the flat display 1 and the mask 2. This material can be enclosed by a seal or can be arranged in a closed member of a flexible or transparent plastic material or glass.

What is claimed is:

1-5. (canceled)

6. An arrangement for spatial stereoscopic and/or holographic representation of information, the arrangement comprising:
a flat display having a rough surface;
a frontal mask connected to the flat display;
at least one of a transparent material and an immersing material arranged between the rough surface and the frontal mask.

7. The arrangement according to claim 6, wherein the at least one of the transparent material and the immersing material is at least one of an immersing layer (4) and a transparent layer (5) provided on the rough surface of the flat display (1).

8. The flat display according to claim 7, further comprising at least one anti-reflective λ/2 layer, wherein at least one of the immersing layer, the transparent layer, and the mask (2) is provided with the at least one λ/2 layer.

9. The arrangement according to claim 6, wherein between the rough surface of the flat display (1) and the mask (2) a space is provided and wherein the at least one of the transparent material and the immersing material is a closed body comprised of the transparent material and containing the immersing material, wherein the closed body is positioned in the space between the rough surface of the flat display (1) and the mask (2).

10. The flat display according to claim 6, wherein between the rough surface of the flat display (1) and the mask (2) a space is provided and wherein the immersing material is arranged in the space and the space is sealed.

11. The flat display according to claim 6, wherein the mask (2) is slidably arranged relative to the rough surface of the flat display (1).
